(19) United States
(12) Patent Application Publication
(10) Pub. No.: US 2011/0289408 A1
(43) Pub. Date: Nov. 24, 2011

(54) MENU PATH TRACKING AND DISPLAY OF PATH STEPS

(76) Inventor: SUCHITHRA NARASIMHALU CHITLUR, Karnataka (IN)

(21) Appl. No.: 12/782,523

(22) Filed: May 18, 2010

(51) Int. Cl. G06F 3/048

(52) U.S. Cl. 715/702; 715/854

(57) ABSTRACT

A wireless handset and method that allows selection and display of steps from a path of commands is described. More particularly, the wireless handset comprises a processor, a display, a first directory, a first-level subdirectory, and a navigation tracking list. The processor supports functions performed by the handset. The first-level subdirectory is associated with the first directory such that the first-level subdirectory is accessed from the first directory. The navigation tracking list is presented on the display. The navigation tracking list includes a first text box representing the first directory and a second text box representing the first-level subdirectory. The second text box is adjacent to the first text box. The user interface is configured to receive a selection from one of the first text box and the second text box.

### FIELD OF THE INVENTION

The present invention relates to a wireless handset and method for selecting between a first directory and a first-level subdirectory displayed on the wireless handset. More particularly, the invention relates to the display of a navigation tracking list, in which a user interface is configured to receive a selection from one of a first directory representation and a first-level subdirectory representation.

### BACKGROUND

Selecting a file or performing an operation on a wireless handset often requires navigation through a series of directories. To move between directories, the user must repeatedly press a back key or soft key to move back through each step of the directory path traversed. Thus, a user cannot move directly from the current step in the path to the first step in the path without paging through each step between the first step and the current step. For example, a user viewing a message accessed through a series of directories cannot move back to the initial directory without hitting the back key to move through each directory.

At present, wireless handsets lack a practical method to display the path of commands leading to the current state of the device. Repeated pressing of a back key or soft key to move through the path is inefficient and frustrating. For example, some users may have difficulty remembering the steps in the path and thus experience frustration when trying to access a particular step in the path. In general, the current wireless handsets and related navigation methods are not user-friendly.

### SUMMARY

A wireless handset and method that allows menu path tracking and display of path steps is described. The menu path tracking and display of the path steps is described by referring to a navigation tracking list that includes an illustrative first text box representing a first directory and an illustrative second text box representing a first-level subdirectory, wherein the first-level subdirectory is accessed from the first directory. The navigation tracking list is presented on the display and the user interface is configured to receive a selection from one of the illustrative first text box and the illustrative second text box.

In one embodiment, the wireless handset comprises a processor, a display, a first directory, a first-level subdirectory, and a navigation tracking list. The processor supports functions performed by the handset. The display is operatively coupled to the processor. The display presents a user interface that is configured to receive commands for navigating among the functions to be performed by the handset. The first-level subdirectory is associated with the first directory such that the first-level subdirectory is accessed from the first directory. The navigation tracking list is presented on the display. The navigation tracking list includes a first text box representing the first directory and a second text box representing the first-level subdirectory. The second text box is adjacent to the first text box. The user interface is configured to receive a selection from one of the first text box and the second text box.

In another illustrative embodiment, the wireless handset may also comprise a processor, a display, a first directory, a first-level subdirectory, and a means for selecting between a first directory representation and a first-level subdirectory representation. The means for selecting includes having the first-level subdirectory representation adjacent to the first directory representation. The user interface enables a selection from one of the directory representation and the first-level subdirectory representation.

A method for selecting between a first directory and a first-level subdirectory displayed on a wireless handset is also described. The method comprises populating a navigation tracking list with a first text box associated with the first directory that corresponds to a first accessed directory and a second text box associated with the first-level subdirectory accessed from the first directory, wherein the first text box is adjacent to the second text box. The method continues by displaying the navigation tracking list on a wireless handset display. The method then receives an instruction that selects one of the displayed text boxes. The method continues by displaying one of the first directory when the first text box is selected and the first-level subdirectory when the second text box is selected.

### DRAWINGS

The present invention will be more fully understood by reference to the following drawings which are for illustrative, not limiting, purposes.

FIGS. 1A-1C show illustrative wireless handsets.

FIG. 2 shows an illustrative communication system, in which the wireless handset features a display and keypad operatively connected with a processor.

FIG. 3 shows an illustrative flowchart of the method for selecting a path step from the navigation tracking list to cause the handset to display the path step.

FIG. 4 shows an illustrative flowchart of the method for populating the navigation tracking list.

FIGS. 5A-5D presents illustrative screenshots indicating the selection of a first directory, a first-level subdirectory, a second-level subdirectory, and a file; and corresponding population of the navigation tracking list with text boxes representing the directories and file.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the wireless handset, systems, and methods described hereinafter may vary as to configuration and as to details.

A wireless handset and method that allows menu path tracking and display of path steps is described. The menu path tracking and display of the path steps is described by referring to a navigation tracking list that includes an illustrative first text box representing a first directory and an illustrative second text box representing a first-level subdirectory, wherein the first-level subdirectory is accessed from the first directory. The navigation tracking list is presented on the display and the user interface is configured to receive a selection from one of the illustrative first text box and the illustrative second text box.

A directory is used to organize files in a hierarchical structure. The first directory may contain one or more subdirectories, files, or a combination thereof. A first-level subdirectory is a directory within a first directory. First-level subdirectories may contain second-level subdirectories, files, or the combination thereof. A file is a collection of data or information that has a name. Almost all information stored in a wireless handset or computer must be a file. A file may be, for example, a text file, a document, or an application.

A menu is a list of commands presented to a user. With respect to a graphical user interface, menus may be presented as text, symbols, or a combination thereof. A common use of menus is to provide convenient access to various operations such as saving or opening a file, quitting a program, or manipulating data.

For purposes of this patent, a “directory” includes, but is not limited to, menus, commands, files, subdirectories, functions, applications, picture files, audio files and other such operations or files associated with the particular directory.

By way of example and not of limitation, the illustrative wireless handset user selects a function or file from a series of directories. For example, to select a particular text message, the user first selects a messaging application from an application menu, and is then presented with a menu specific to the messaging application. The user selects the inbox from the messaging application menu. The handset then displays a list of messages in the inbox. The user selects the first message from the inbox, which is then shown on the handset display. As the menu of applications, messaging application menu, inbox menu, and first message are selected, text boxes representing each menu and the message are displayed in a navigation tracking list in the order which the selections were made.

In other embodiments, a file is accessed from a first directory or a first-level subdirectory of a first directory. In still other embodiments, a function may be selected from a first directory, a first-level subdirectory, or a second-level subdirectory. The navigation tracking list may display the text boxes representing the accessed directories in chronological order or in reverse chronological order. In some embodiments, the navigation tracking list displays representations of the directories, functions, or files traversed by means of graphical icons or other representation in lieu of text box representations. The representations may be listed in list, grid, or other format in which all representations are simultaneously visible on the display screen.

The user may control the wireless handset via a keypad or touch screen. The control means is used to select an illustrative text box from the navigation tracking list. When a text box is selected, the wireless handset displays the directory indicated by the text box.

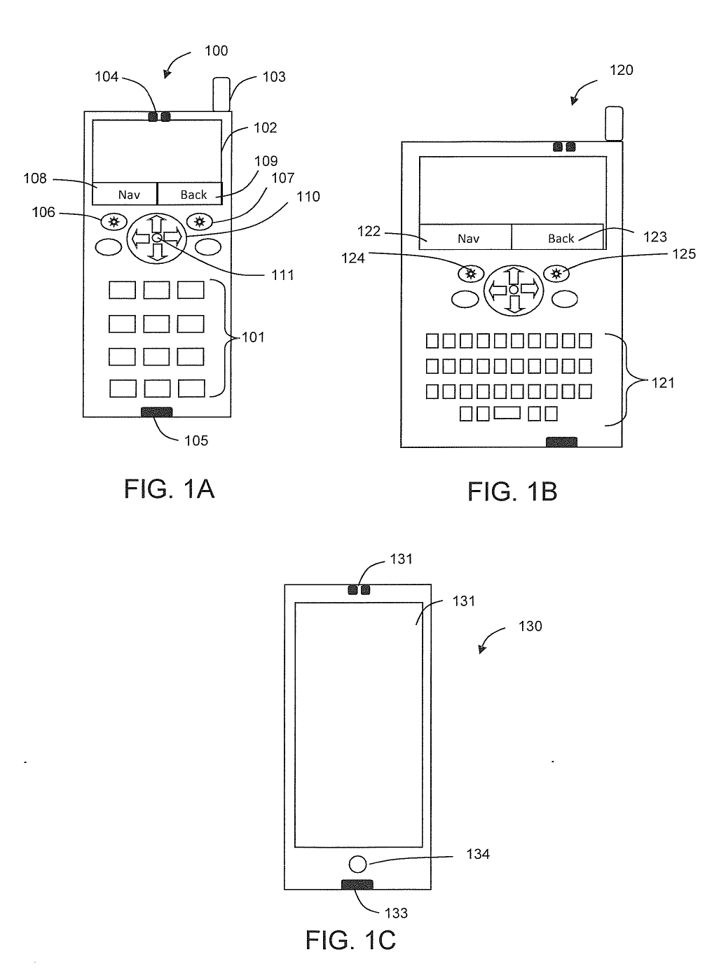

Referring to FIGS. 1A-1C, there are shown wireless handsets 100, 130, and 140. The illustrative wireless handset can also be referred to as a wireless communication device, a mobile handset, mobile phone, wireless phone, portable cell phone, cellular phone, portable phone, a personal digital assistant (PDA), or any type of mobile terminal which is regularly carried by a user and has all the elements necessary for operation in a wireless communication system.

FIG. 1A shows an illustrative wireless handset featuring a numeric keypad 101. The wireless handset includes a display 102, an antenna 103, speaker 104, and a microphone 105. In an exemplary embodiment, some of the keys of the keypad 101 are associated with the text boxes of the navigation tracking list. When the user presses the key associated with a particular text box in the navigation tracking list, the directory represented by the text box is displayed. The wireless handset may feature one or more soft keys, shown in FIG. 1A as 106 and 107.

A soft key is a key which may be programmed to perform different functions in different contexts, rather than being associated with a particular function. The soft key is typically adjacent to the display. The current functionality of the soft key is often indicated by text on the display positioned adjacent to the soft key. In FIG. 1A, the functionality of soft keys 106 and 107 is indicated by the text shown in soft key text boxes 108 and 109, respectively. Thus, in the embodiment shown, pressing soft key 106 will activate the “Back” function, resulting in navigation back to the prior screen shown on the display, and pressing soft key 107 activates the “Nav” function.

The Nav function toggles between the soft key menu and the navigation tracking list. Thus, when the Nav function is activated, control would transfer from the soft key menu comprised of the text boxes 108 and 109 to the navigation tracking list. This shift in control may be indicated with highlighting, such that text or the background of the soft key indicator is highlighted when the soft key menu is the active control, and the text or the background of the navigation tracking list items is highlighted when the navigation tracking list is in control. Other means may be used to indicate in what part of the display selection controls are active. In another embodiment, the Nav function results in replacement of the soft key menu with the navigation tracking list.

A navigation key 110 may be included on the wireless handset. The navigation key features directional controls and may additionally include a selection control. The navigational key may include two-way directional controls (up and down, or left and right), four-way directional controls (up, down, left, and right), or more directional controls, such as an omnidirectional control. The navigational key can be a rocker-type control, issuing a direction control command when the key is depressed in one of the available directions. The selection control may be a separate button in the center of the navigation key, activated when the center button is pressed. Alternatively, the selection control may be integrated into the navigation key, activated when the navigation key is pressed inward (rather than in an available direction). Another navigational key embodiment is a roller-type control, moving a cursor on the display in any direction in which the control is rolled. The selection control of the roller-type control may be activated when the roller-type control is pressed inward. Alternatively, the selection control may be a separate button from the roller-type control.

In FIG. 1A, the directional controls of rocker-type navigation key 110 are indicated by arrows, with the direction control issued when the navigation key is rocked in the direction of one of the arrows. Navigation key 110 also features a center button selection control 111. The navigation key may be used to select an item from the navigation tracking list. In one exemplary embodiment, the navigation tracking list is displayed horizontally on the display, and the user presses the right and left directional controls of navigation key 110 until the desired text box is highlighted, then presses the center button to select that text box.

Referring to FIG. 1B, an illustrative wireless handset 120 featuring a QWERTY-type keypad 121 is shown. The QWERTY keypad may include a tab key which can be used to switch between the navigation tracking list and the soft key menu comprised of text boxes 124 and 125. One of soft keys 122 and 123 may be used to toggle between the navigation tracking list and the soft key menu. Alternatively, some of the keys of keypad 121 may be associated with text boxes in the navigation tracking list. The soft key and navigation key descriptions for the handset shown in FIG. 1A are incorporated by reference into the description of FIG. 1B.

Referring to FIG. 1C, an illustrative wireless handset 130 is shown, featuring a display 131 that functions as a touch screen interface. A touch screen is able to detect the presence and location of a finger, stylus, or other indicating means when the indicating means comes into contact with the screen. The wireless handset further includes speaker 132, microphone 133, and a home button 134. The home button 134 may return the device to a “home” screen, which may be the default screen displayed on the device and may comprise time, date, upcoming events from a calendar application, application menu, or the combination thereof. The home button 134 may alternatively function as a soft key, as described above in the description of FIG. 1A.

In an exemplary embodiment, the navigation tracking list is shown on display 131. A user can select a path step from the navigation tracking list by touching the text box or icon associated with that path step. The home screen or other operating system screen may feature an icon or graphical button on the touch screen, the activation of which results in the display of the navigation tracking list.

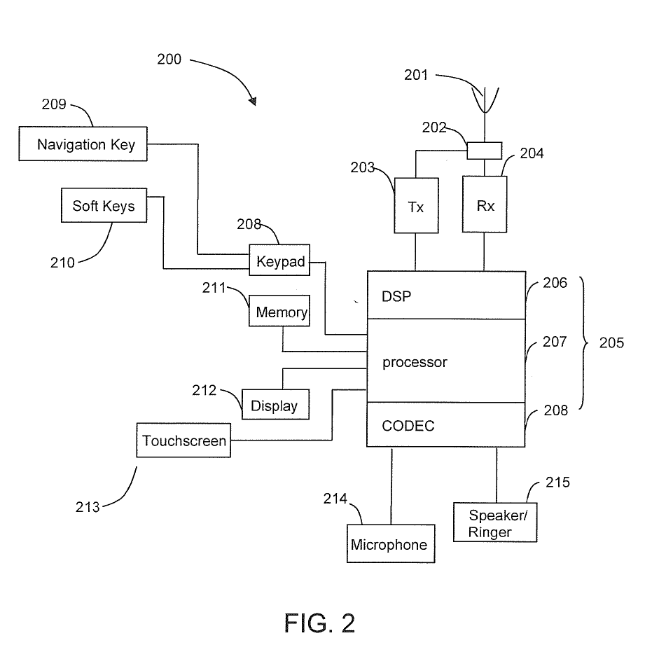

Referring to FIG. 2, there is shown a plurality of components associated with an illustrative wireless handset. The illustrative multimode wireless handset 200 comprises a first antenna element 201 that is operatively coupled to a duplexer 202, which is operatively coupled to a multimode transmitter module 203, and a multimode receiver module 204.

An illustrative control module 205 comprises a digital signal processor (DSP) 206, a processor 207, and a CODEC 208 that are communicatively coupled to the transmitter 203 and receiver 204. It shall be appreciated by those of ordinary skill in the art that the transmitter module and receiver module are typically paired and may be embodied as a transceiver. The DSP 206 may be configured to perform a variety of operations such as controlling the antenna 201, the multimode transmitter module 203, and the multimode receiver module 204.

The processor 207 is operatively coupled to a keypad 208, memory 211, and display 212. Additionally, the processor 207 is also operatively coupled to a CODEC module 208 that performs the encoding and decoding operations and is communicatively coupled to microphone 214 and a speaker or ringer 215. The CODEC module 205 is also communicatively coupled to the display 212 and provides the encoding and decoding operations for video. In some embodiments, the processor is additionally operatively coupled to a touch screen interface 213.

Keypad 208 may comprise one or more soft keys 210, a navigation key 209, or a combination thereof. The soft key and navigation key are described in more detail in the description of FIG. 1A above.

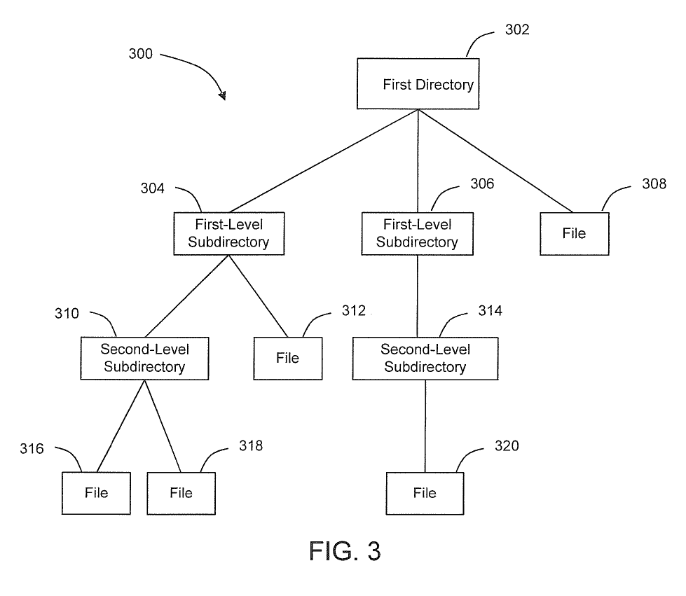

Referring to FIG. 3, there is shown a diagram illustrating an exemplary embodiment of a directory. A directory is an organizational unit used to organize files in a hierarchical structure as described above.

For example, a user may access an illustrative first directory 302. The illustrative first directory 302 includes the combination of two first-level subdirectories 304 and 306, and a file 308. In general, a subdirectory is a directory within another directory. In the illustrative first directory 302, the first-level subdirectories 304 and 306, and file 308 are within the first directory 302. The second-level subdirectories 310 and 314 are associated with subdirectories 304 and 306, respectively; illustrative subdirectories 310 and 314 are two levels below the first directory 302.

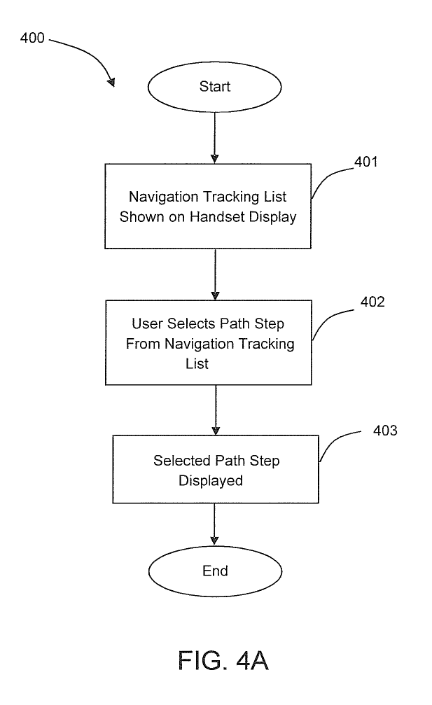

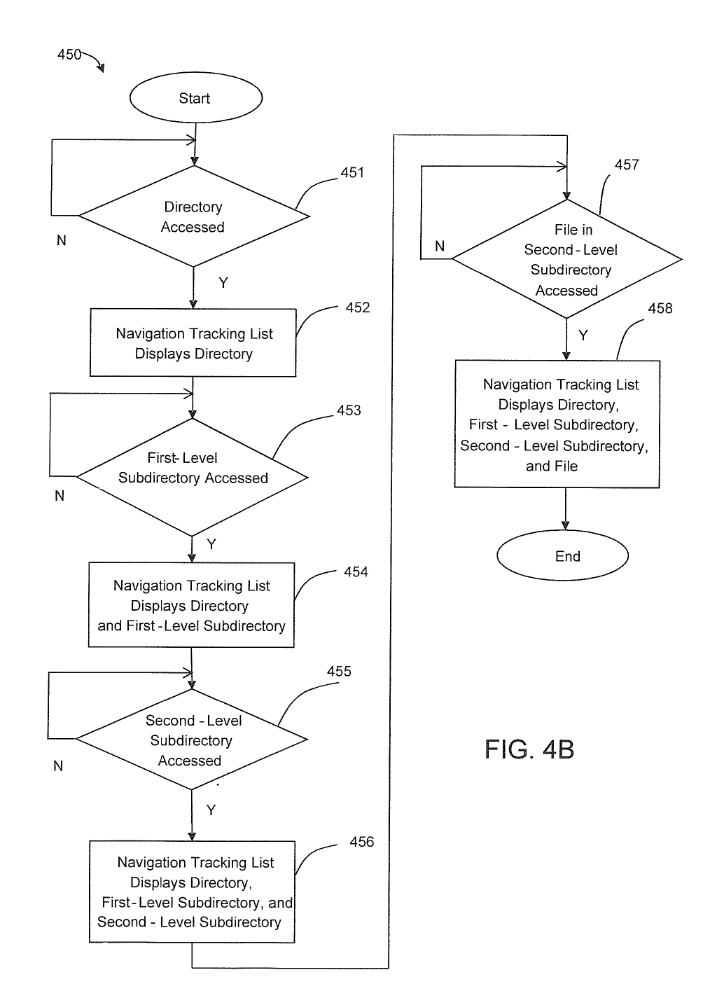

Referring to FIG. 4A, there is shown an illustrative flowchart 400 of the method for selecting a path step from the navigation tracking list to cause the handset to display the path step. The illustrative flowchart is initiated at block 401, in which the navigation tracking list is shown on the handset display. The navigation tracking list is populated with directories, functions, or files that have been sequentially accessed on the handset. An exemplary method for populating the navigation tracking list is shown in FIG. 4A. The navigation tracking list may be displayed in response to the issuance of a command through means such as a pressed key or selected graphical button or icon, as explained further in the descriptions of FIGS. 1A-1C. In other embodiments, the navigation tracking list may be visible on the display while the device is in normal operating mode, or the navigation tracking list may be displayed in response to the selection of an application, function, directory, or other such operations.

At step 402 of FIG. 4A, the user selects an item from the navigation tracking list. After the selection is made, the path step associated with the navigation tracking list item selected is shown on the display of the wireless handset, as indicated at step 403. The path step may be a directory, file, or function accessed prior to the current device state.

Referring to FIG. 4B, there is shown an illustrative flowchart 450 of an exemplary method for populating an exemplary navigation tracking list. The flowchart is initiated at decision diamond 451, in which a determination is made whether a first directory has been accessed. If a first directory has been accessed, the navigation tracking list is populated with a text box associated with the first directory, as indicated at step 452.

The processor then determines whether a first-level subdirectory has been accessed, as indicated at decision diamond 453. When a first-level subdirectory has been accessed, the tracking list is populated with a text box associated with the first-level subdirectory, as indicated at step 454. By way of example, the text box associated with the first-level subdirectory is adjacent to the text box associated with the first directory in the navigation tracking list. The adjacency of the first-level subdirectory text box and first directory text box communicates the order that these directories are accessed.

At decision diamond 455, the determination of whether a second-level subdirectory has been accessed is performed. When a second-level subdirectory has been accessed, the tracking list is populated with a text box associated with the second-level subdirectory, as indicated at block 456. The text box associated with the second-level subdirectory is adjacent to the text box associated with the first-level subdirectory in the navigation tracking list.

The illustrative processor may then determine whether a file within the second-level subdirectory has been accessed, as represented by decision diamond 457. When a file within the second-level subdirectory has been accessed, the tracking list is populated with a text box associated with the file, as indicated by block 458. The text box associated with the file is adjacent to the text box associated with the second-level subdirectory.

The navigation tracking list may be populated from varying file structures in a manner similar to that illustrated in FIG. 4B. For example, a file may be in a first directory. In this case, the navigation tracking list is populated with a text box associated with the first directory, such as file 308 in FIG. 3. Then, the file is accessed from the first directory and the navigation tracking list is populated with a text box associated with the file, the text box associated with the file adjacent to the text box associated with the first directory. In another example, a file may be in a first-level subdirectory, such as file 312 in FIG. 3. In a further example, a function is accessed from a first directory, a first-level subdirectory, or a second-level subdirectory.

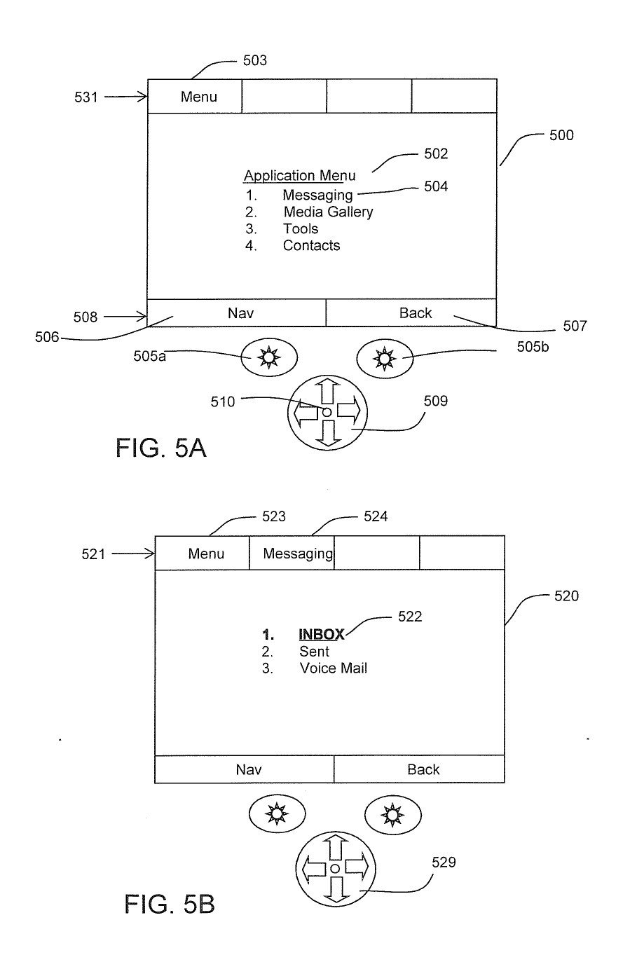

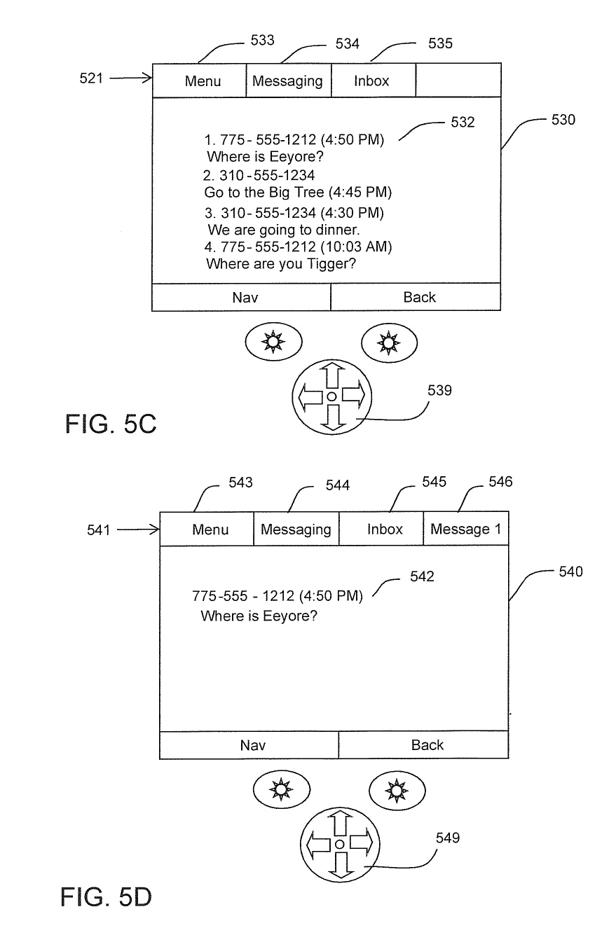

Referring to FIG. 5A, an illustrative screenshot is shown, indicating the selection of a first directory and resulting population of the navigation tracking list with a text box associated with the directory. In the illustrated embodiment, navigation tracking list 501 is at the top of display 500. In another embodiment, the navigation tracking list may be at the bottom of display 500. Alternatively, the navigation list may be displayed vertically along the left or right side of the display 500.

In FIG. 5A, the display 500 indicates that a first directory 502 has been accessed. First directory 502 is an application menu, listing various applications available on the wireless handset. As a result of the first directory having been accessed by the user, the navigation tracking list has been populated with a first text box 503. The text in text box 503, “Menu,” indicates that the first directory was a menu, in this case, a menu of applications. Soft keys 505a and 505b are associated with the functions indicated in soft key text boxes 506 and 507, respectively.

In the illustrative embodiment, pressing soft key 505a activates the function indicated in text box 506, “Nay.” The “Nav” function toggles control between the soft key menu 508 and the navigation tracking list 501. Thus, pressing soft key 505a results in navigation tracking list 501 becoming the active menu. Navigation key 509 may be used to select among items in soft key menu 508 and may also be used to select among items in navigation tracking list 501. When the navigation tracking list 501 is highlighted, directional controls of navigation key 509 are used to move between and select the text boxes comprising the navigation tracking list.

The user may use navigation key 509 to select an application from the application menu. The navigation key 509 may feature a command for moving up or down between highlighted selectable options in a vertically presented list such as the application menu 502. For example, if “Messaging,” list item 1 (element 504) in the application menu, is highlighted, the user may use a “down” control on the navigation key to move down to the other application options in the application menu, or the user may press the center button 510 to select the Messaging application.

FIG. 5B shows a second state of the wireless handset subsequent to the state shown in FIG. 5A. In FIG. 5B, the display 520 indicates that an application, Messaging, has been selected from the application menu shown in FIG. 5A. As a result, text box 524 of navigation tracking list 521 has been populated with text associated with the application, “Messaging.” The Messaging application has an associated directory 522. Directory 522 is a subdirectory of first directory 502 shown in FIG. 5A. Thus, directory 522 is a first-level subdirectory.

The user may use navigation key 529 to select among the text boxes shown in navigation tracking list 521. If the user selects text box 523, “Menu,” the display 520 will show the application menu as depicted in FIG. 5A.

FIG. 5C shows a third state of the wireless handset subsequent to the state shown in FIG. 5B. In FIG. 5C, item one from directory 522 of FIG. 5B, “Inbox,” has been selected by the user. As a result, text box 535 of navigation tracking list 531 has been populated with text representing the application, “Inbox.” The Inbox has an associated directory 532, listing the messages in the Messaging application inbox; directory 532 is a second-level subdirectory.

The user may then use navigation key 539 to select among the text boxes shown in navigation tracking list 531. If the user selects text box 533, “Menu,” the display 530 will show the application menu as depicted in FIG. 5A. If the user selects text box 534, “Messaging,” the display 530 will show the Messaging menu as depicted in FIG. 5B.

FIG. 5D shows a fourth state of the wireless handset subsequent to the state shown in FIG. 5C. In FIG. 5D, item one from directory 532 of FIG. 5B has been selected by the user. As a result, text box 546 of navigation tracking list 541 has been populated with text representing the message file 542, “Message 1.” Thus, Message 1 is a file 542 in second-level subdirectory 532 shown in FIG. 5B.

The user may use navigation key 549 to select among the text boxes shown in navigation tracking list 541. If the user selects text box 543, “Menu,” the display 540 will show the application menu as depicted in FIG. 5A. If the user selects text box 544, “Messaging,” the display 540 will show the Messaging menu as depicted in FIG. 5B. If the user selects text box 545, “Inbox,” the display 540 will show the Inbox message list as depicted in FIG. 5C.

A navigation tracking list for displaying steps in a path traversed on a wireless handset has been described above. Selection of an item from the navigation tracking list results in the display of the path step represented by that item. Alternatively, the navigation tracking list may be the only content shown on a screen accessed by various initiation means, including the pressing of a key or graphical button or icon.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A wireless handset, comprising:
a processor to support a plurality of functions to be performed by the handset;
a display operatively coupled to the processor, wherein the display presents a user interface, the user interface configured to receive commands for navigating among the functions to be performed by the handset;
a first directory;
a first-level subdirectory associated with the first directory, wherein the first-level subdirectory is accessed from the first directory;
a navigation tracking list presented on the display, wherein the navigation tracking list includes,
a first text box representing the first directory, and
a second text box representing the first-level subdirectory, the second text box adjacent to the first text box;
wherein the user interface is configured to receive a selection from one of the first text box and the second text box.

2. The wireless handset of claim 1 further comprising a second-level subdirectory associated with the first-level subdirectory, wherein the second-level subdirectory is accessed from the first-level subdirectory.

3. The wireless handset of claim 2 further comprising a third text box that is associated with the second-level subdirectory, wherein the third text box is adjacent to the second text box.

4. The wireless handset of claim 1, further comprising a numeric keypad having a plurality of keys.

5. The wireless handset of claim 4, wherein at least one of the keys of the keypad is associated with the text boxes presented in the navigation tracking list.

6. The wireless handset of claim 4, further comprising a navigation key, wherein the navigation key is configured to select one of the text boxes displayed in the navigation tracking list.

7. The wireless handset of claim 1, further comprising a QWERTY keypad.

8. The wireless handset of claim 1, further comprising a touch screen interface, wherein the touch screen interface is configured to select among the text boxes displayed in the navigation tracking list.

9. A wireless handset, comprising:
a processor to support a plurality of functions to be performed by the handset;
a display operatively coupled to the processor, wherein the display presents a user interface, the user interface configured to receive commands for navigating among the functions to be performed by the handset;
a first directory associated with a first directory representation;
a first-level subdirectory associated with a first-level subdirectory representation, wherein the first-level subdirectory is accessed from the first directory;
a means for selecting between the first directory representation and the first-level subdirectory representation, the first-level subdirectory representation adjacent to the directory representation;
wherein the user interface enables a selection from one of the first directory representation and the first-level subdirectory representation.

10. The wireless handset of claim 9 further comprising a second-level subdirectory associated with the first-level subdirectory, wherein the second-level subdirectory is accessed from the first-level subdirectory.

11. The wireless handset of claim 10 further comprising a second-level directory representation that is associated with the second-level subdirectory, wherein the second-level directory representation is adjacent to the first-level subdirectory representation.

12. The wireless handset of claim 9, wherein the means for selecting further comprises a navigation key that is configured to select one of the first directory representation and the first-level subdirectory representation.

13. The wireless handset of claim 9, further comprising a numeric keypad having a plurality of keys.

14. The wireless handset of claim 13, wherein at least one of the keys of the keypad is associated with one of the first directory representation and the first-level subdirectory representation.

15. The wireless handset of claim 9, further comprising a QWERTY keypad.

16. The wireless handset of claim 9, further comprising a touch screen interface, wherein the touch screen interface is configured to select among the first directory representation and first-level subdirectory representation.

17. A method for selecting between a first directory and a first-level subdirectory displayed on a wireless handset, the method comprising:
populating a navigation tracking list with a first text box associated with the first directory that corresponds to a first accessed directory and a second text box associated with the first-level subdirectory accessed from the first directory, wherein the first text box is adjacent to the second text box;
displaying the navigation tracking list on a display of the wireless handset;
receiving an instruction that selects one of the displayed text boxes;
displaying one of the first directory when the first text box is selected and the first-level subdirectory when the second text box is selected.

18. The method of claim 17 further comprising populating the navigation tracking list with a third text box associated with a second-level subdirectory that is accessed from the first-level subdirectory.

19. The method of claim 17, further comprising:
associating at least one key that corresponds to a keypad for the wireless handset with the text boxes presented in the navigation tracking list;
using the keys to select among the displayed text boxes.

20. The method of claim 19, further comprising using a navigation key to select among the text boxes displayed in the navigation tracking list.

21. The method of claim 19, further comprising using a soft key to select between a soft key menu and a navigation tracking list.

22. The method of claim 19, further comprising using a tab key to select between a soft key menu and a navigation tracking list.
